(19) United States
(12) Patent Application Publication
(10) Pub. No.: US 2011/0048262 A1
(43) Pub. Date: Mar. 3, 2011

(54) INTEGRAL SHEET HOLD-DOWN DEVICE FOR UV LED CURING LAMP

(76) Inventors: Aaron D. Martinez, Arvada, CO (US); Stephen J. Metcalf, Hudson, WI (US)

(21) Appl. No.: 12/868,833

(22) Filed: Aug. 26, 2010

Related U.S. Application Data
(60) Provisional application No. 61/237,442, filed on Aug. 27, 2009.

(51) Int. Cl. B41L 21/06; B41L 49/00

(52) U.S. Cl. 101/408; 101/480; 101/479

(57) ABSTRACT

A device such as a row of wheels, a row of pressurized air blasts, or guide fingers is attached directly to a UV LED lamp that is mounted into a sheet-fed printing press for curing UV inks and coatings. The device will enable the UV LED lamp to be placed closer to the sheet than previously possible by preventing the trailing edge of the sheet from dragging across the UV LED lamp as the sheet passes by the lamp.

### CROSS-REFERENCES TO RELATED APPLICATIONS

This application claims priority under 35 U.S.C. §119(e) to, and hereby incorporates by reference, U.S. Provisional Application No. 61/237,442, filed 27 Aug. 2009.

### BACKGROUND OF THE INVENTION

1. Field of the Invention

The present invention relates to a method and apparatus for preventing the trailing edge of the sheet in a sheet-fed printing press from dragging across the adjacent surface of a UV LED lamp, thus allowing the lamp to be placed closer to the sheet line-of-travel.

2. Background

UV LED lamps are used in the application of UV-curing of inks, coatings, and adhesives having UV photo initiators therein. The nature of the light emitted from UV LED lamps often requires that the lamps be placed as close to the sheet line-of-travel as possible to achieve effective curing.

In a sheet-fed printing press, the leading edge of the sheet is held stable by grippers while the trailing edge of the sheet is left free to flutter up and/or down as imposed by the motion of the printing process. If the trailing edge of the sheet drags across anything prior to the ink being cured, the ink will be marred, which is unacceptable from the standpoint of the printer. This fluttering of the trailing edge requires that the UV LED lamp be placed much farther from the sheet than is optimal for curing.

### BRIEF SUMMARY OF THE INVENTION

A device is attached to a UV LED lamp preventing the trailing edge of the sheet from contacting the lamp as the sheet passes by the lamp. The device prevents the sheet from contacting the UV LED lamp as it passes by the lamp thereby enabling the lamp to be placed in locations within the printing process that may not be possible otherwise. The UV LED lamp may be located in a position closer to the sheet line-of-travel which is advantageous from the standpoint of the LED light as the intensity of the light emitted by LEDs diminishes inversely proportional to the square of the distance from the LED to the substrate. Thus, positioning the UV LED lamp closer to the sheet line-of-travel may result in higher irradiation intensity on the sheet from the UV LED lamp.

Sheet-fed printing presses often have integral sheet-guiding features that, if a UV LED lamp were to be placed over such a feature, would result in a shadow being cast onto the sheet by the sheet-guide feature. The presence of this shadow could diminish the amount of UV radiation impinging the sheet and thereby inhibit curing of the UV-curable product present in the shaded region. The present device would enable the UV LED lamp to be placed in areas of the printing process where there are no sheet-guiding features between the UV LED lamp and the sheet line-of-travel.

If the device makes contact with the sheet then the device is to be located on the UV LED lamp such that the device does not contact the sheet until after the UV-curable product has been cured. Prior to being cured, UV-curable products may be greasy or sticky in texture and in any case are very easily smeared, smudged, or marred if anything contacts them. Upon curing, the UV-curable product hardens and becomes more durable. Locating the device of this invention such that it contacts the sheet after the UV-curable product has been cured will significantly reduce the possibility for damage to occur to the UV-curable product as a result of contact between the sheet and the device.

If the device makes contact with the sheet then the device will also be made of a material that is smooth and has a very low coefficient of friction. Making the device from a smooth material with a low coefficient of friction will further reduce the possibility for damage to occur to the UV-curable product when it comes in contact with the device.

If the device makes contact with the sheet then the device may also be designed so that it rolls in the direction of motion of the sheet. Making the device such that it has the ability to roll may further reduce friction between the device and the sheet, and further prevent marking, scuffing, or any other damage that may be caused to the sheet by its contact with the device.

If the device makes contact with the sheet then the position of the device on the UV LED lamp may be adjustable so that the device contacts the sheet in a region that does not receive ink or coating. Making the position of the device on the UV LED lamp adjustable so that the device contacts the sheet in a region that does not receive ink or coating ensures that the ink or coating will not be smeared smudged or marred during printing.

### BRIEF DESCRIPTION OF THE DRAWINGS

FIG. 1 is an illustration of the problem with the prior art showing the tail of a sheet dragging across the bottom of a UV LED lamp.

FIG. 2a is a perspective view of one embodiment of the device of the invention in the form of a row of wheels made of a smooth material with a low coefficient of friction.

FIG. 2b is a perspective view of one of the wheel mechanisms depicted in FIG. 2a.

FIG. 2c is an exploded view of the wheel mechanism of FIG. 2b.

FIG. 3 is the embodiment illustrated in FIG. 2 shown in place in the sheet-fed printing press illustrated in FIG. 1.

FIG. 4 is one embodiment of the device of the invention in the form of a blast of air shown in place in the sheet-fed printing press illustrated in FIG. 1.

FIG. 5 is another embodiment of the device of the invention in the form of a row of curved fingers made from a smooth material with a low coefficient of friction that have adjustable positioning such that they can be made to contact the sheet in unprinted regions.

It is understood that the above-described figures are only illustrative of the present invention and are not contemplated to limit the scope thereof.

### DETAILED DESCRIPTION OF THE INVENTION

The following is a description of a device that is attached to a UV LED lamp that prevents the trailing edge of the sheet from contacting the lamp as the sheet passes by the lamp. The examples and figures that follow are intended to teach a person skilled in the art how to effectively design and implement the present invention, but are not intended to limit the scope of the invention. The features and methods disclosed in the detailed description may be used separately or in conjunction with other features and methods to provide improved devices of the invention and methods for making the same. The features and methods disclosed in this detailed description may not be necessary to practice the invention in the broadest sense, but are provided so that a person of skill in the art may further understand the details of the invention.

The sheets in a sheet-fed printing press can travel at very high velocities and change direction frequently. The sheet is pulled through the press by its leading edge, but the trailing edge is left free to flip or flutter up and down, especially when the sheet is thick like board stock for example. Typically, when a UV LED lamp is mounted in a sheet-fed printing press, it must be positioned such that the distance between the sheet line-of-travel and the adjacent surface of the UV LED lamp is large enough to accommodate the flipping or fluttering of the sheets trailing edge such that the sheet does not contact the UV LED lamp. Thin sheets that are more flexible tend to maintain the shape of the impression cylinder and may be much less likely to flip up into the lamp.

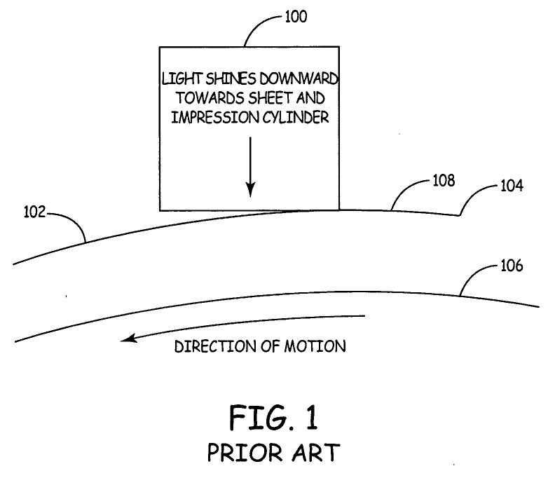

When using LEDs as a light source it is often beneficial to position the LEDs as close to the substrate as possible which may be a disadvantage when using UV LED lamps in a sheet-fed printing press, especially when the substrate is thick. FIG. 1 is an illustration of the situation when the UV LED lamp 100 is placed too close to the sheet line-of-travel 102. The trailing edge 104 of the sheet can flip up when it is coming around the impression cylinder 106 and then drag across the UV LED lamp 100 which will damage the UV-curable product 108 that had been previously applied to the sheet 102.

At present, one solution to the problem illustrated in FIG. 1, which will hereafter be referred to as prior art solution 1, has been to position the UV LED lamp 100 far enough from the sheet 102 line-of-travel to allow the trailing edge 104 of the sheet 102 to pass without contacting the lamp 100. An alternative solution, which will hereafter be referred to as prior art solution 2, has been to restrict the sheet thickness to thin sheets that easily maintain the shape of the impression cylinder 106 and may not flip up into the lamp 100. Each of these solutions has disadvantages that are overcome by the invention disclosed herein.

The disadvantage of prior art solution 1 is that the intensity of the UV energy that is incident upon the UV-curable product 108 that has been applied to the sheet 102 may be reduced when the distance between the lamp 100 and the sheet 102 line-of-travel is increased. The disadvantage of prior art solution 2 is that many UV-curable products are printed on sheets that are thick, like product packaging for example. Also, sheet-fed printing presses are designed to accommodate thick sheets as well as thin sheets. Installing UV LED lamps into a sheet-fed printing press in a manner that restrict its versatility could be counterproductive. The present invention enables a UV LED lamp to be located into a sheet-fed printing press such that it is adequately close to the sheet 102 line-of-travel so that the intensity of the UV energy that is incident upon the UV-curable product 108 that has been applied to the sheet 102 may be higher, and the versatility of the printing press with regard to sheet thickness will not be limited.

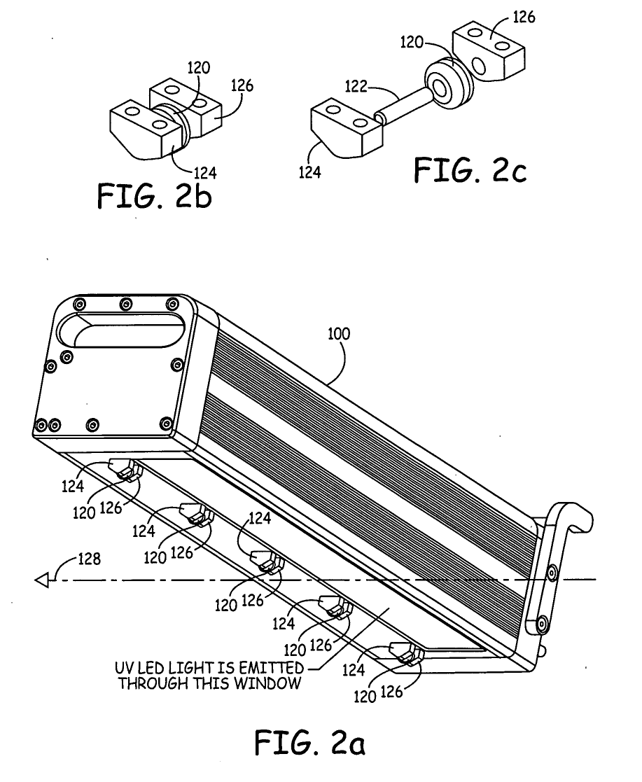

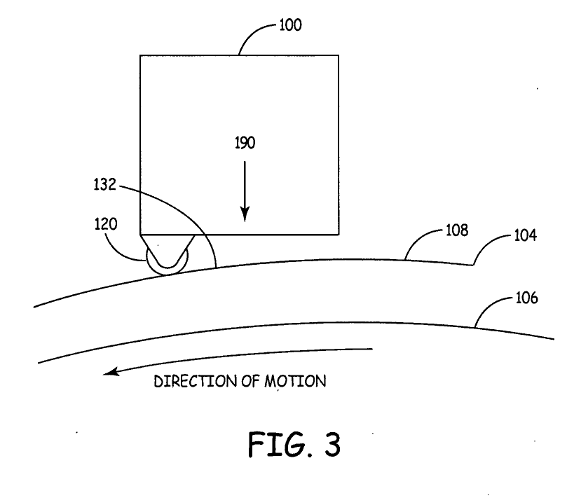

FIGS. 2a, 2b, and 2c illustrate one embodiment of the invention that has a hold-down mechanism such as a row of small smooth wheels 120 mounted on shafts 122 that are trapped between a mounting mechanism such as yoke blocks 124, 126 that are fastened to the bottom of the UV LED lamp 100. The wheels 120 would be manufactured so that they are smooth, and made of a low friction material such as polytetrafluoroethylene. The wheels 120 would pivot about the shafts 122 and would be oriented such that the wheels 120 roll in the direction of motion 128 of the sheet. FIG. 3 illustrates how the wheels 120 would push the sheet 102 away from the UV LED lamp 100 in a manner that would prevent damage to the UV-curable product 108. The wheels 120 are also mounted in a location such that the UV-curable product 108 is irradiated by the UV light 130, and is therefore cured 132, before it comes into contact with the wheels 120.

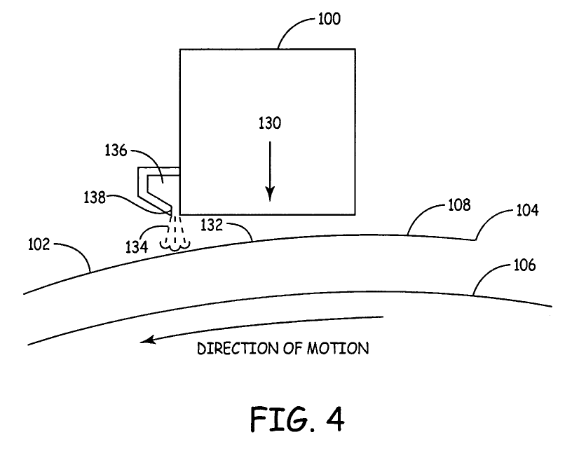

FIG. 4 illustrates one embodiment of the invention that has a hold-down mechanism which provides a blast of air 134 that pushes the sheet 102 away from contact with the UV LED lamp 100. The blast of air 134 could come from a pressurized reservoir 136 that would run the length of the UV LED lamp 100 and could either blow out through a long thin slit 138 that is directed towards the sheet 102, or through a series of holes that are directed towards the sheet 102. A mounting mechanism such as a plurality of fasteners attaches the reservoir 136 to the lamp 100. The air blast 134 could be intermittent, blasting only when the latter half of the sheet 102 is adjacent the UV LED lamp 100, or the air blast 134 could be constant, blasting the entire time that the printing process is running. It may also be beneficial to mount the air blast in a location such that the UV-curable product 108 is irradiated by the UV light 130, and is therefore cured 132, before it comes into contact with the air blast 134.

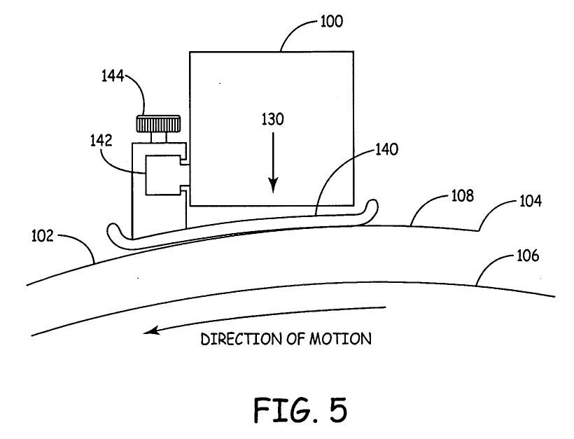

FIG. 5 illustrates one embodiment of the invention that includes a hold-down mechanism such as a row of guide fingers 140 for contacting the sheet in regions along the sheet wherein UV-curable product 108 has not been applied. Said row of wheels could suitably be distributed in the longitudinal direction of the UV LED lamp 100 and a possible preferred quantity of guide fingers in said row could be three or four. The guide fingers 140 could suitably be mounted to the UV LED lamp 100 in fixed positions. The guide fingers 140 could suitably be mounted to the UV LED lamp 100 in a manner that their position in the longitudinal direction would be adjustable which longitudinal direction corresponds to in and out of the page of FIG. 5. This adjustability of the guide fingers 140 would enable the operator to locate the guide fingers 140 in regions along the sheet wherein UV-curable product 108 has not been applied. The adjustability of the guide fingers 140 could be achieved by mounting the guide fingers 140 to a guide rail 142 that is attached to the UV LED lamp 100. The guide fingers 140 could be fastened to the guide rail 142 with thumb screws 144 or the like that would enable the guide fingers 140 to be easily loosened for adjustment and then tightened to remain in position during operation.

Because numerous modifications of the present invention may be made without departing from the spirit thereof, the scope of this invention is not to be limited by the embodiments illustrated and described. Rather, the scope of the invention is to be determined by the appended claims and their equivalents.

1. A hold-down device for a printing press and comprising:
a hold-down mechanism for maintaining a position of a substrate being printed on said printing press; and
a mounting mechanism for mounting said hold-down device to a stationary object at a desired position.

2. The hold-down device of claim 1, wherein, said hold-down mechanism includes a wheel mounted to a lamp.

3. The hold-down device of claim 2, wherein said mounting mechanism mounts said hold-down mechanism to said lamp.

4. The hold-down device of claim 3, wherein said lamp is an LED lamp emitting UV radiation.

5. The hold-down device of claim 2, wherein said mounting mechanism mounts said hold-down mechanism to a UV LED lamp, said UV LED lamp directing UV radiation at said substrate.

6. The hold-down device of claim 1, wherein said hold-down mechanism includes means for directing an air flow toward said substrate.

7. The hold-down device of claim 1, wherein said hold-down mechanism includes a guide finger.

8. A lamp attachable to a printing press in combination with the hold-down device of claim 1.

9. The lamp of claim 8, wherein said lamp contains at least one LED emitting UV radiation.

10. A printing press in combination with the lamp of claim 8 and the hold-down device of claim 1, said lamp attached to said printing press, said hold-down device attached to said lamp.

11. A method of attaching a hold-down device to a printing press, said hold-down device attached to a UV LED lamp, said method comprising securing said lamp proximate said printing press.

12. The method of claim 11, wherein said attached hold-down device includes a wheel.

13. The method of claim 11, wherein said attached hold-down device includes means for directing an airflow toward a substrate being printed on said printing press.

14. The method of claim 11, wherein said attached hold-down device includes a guide finger.

15. A method of retrofitting a UV LED lamp, comprising attaching a hold-down device to a surface of said lamp.

16. The method of claim 15, wherein said hold-down device is attached to a bottom surface of said lamp.

17. The method of claim 15, wherein said attached hold-down device comprises a wheel.

18. The method of claim 15, wherein said attached hold-down device comprises means for directing an air flow toward a substrate being printed on a printing press.

19. The method of claim 16, wherein said attached hold-down device includes a guide finger.

20. A method for printing a substrate in motion on the surface of an impression cylinder, a UV-curable product present on a surface of said substrate, said method comprising:
directing UV radiation from a UV LED lamp toward said UV-curable product; and
maintaining said substrate a distance from said lamp by a hold-down device attached to said lamp.

21. The method of claim 20, wherein said hold-down device includes a wheel.

22. The method of claim 20, wherein said hold-down device includes means for directing an airflow toward said substrate.

23. The method of claim 20, wherein said hold-down device includes a guide finger.
